(19) United States
(12) Patent Application Publication
(10) Pub. No.: US 2012/0179490 A1
(43) Pub. Date: Jul. 12, 2012

(54) Trusted Partner Medical Records System and Method

(76) Inventors: David E. Fuhrmann, Verona, WI (US); David Andrew Cassel, Waunakee, WI (US); Peter DeVault, Fitchburg, WI (US)

(21) Appl. No.: 13/235,840

(22) Filed: Sep. 19, 2011

Related U.S. Application Data
(60) Provisional application No. 61/384,377, filed on Sep. 20, 2010.

(51) Int. Cl. G06Q 50/24

(52) U.S. Cl. 705/3

(57) ABSTRACT

A method and system for sharing patient medical records among a plurality of separate entities wherein each of the entities maintains a separate electronic medical records (EMR) system, the method comprising the steps of receiving a first data request associated with a first patient via a first entity where the first entity is a requesting, automatically identifying the EMR systems associated with a trusted subset of entities that maintain at least a subset of data associated with the first patient, using the subsets of data from the identified EMR systems to update patient data maintained by the requesting entity wherein the patient data includes patient medical chart data and using the updated patient data maintained by the requesting entity to generate and present a patient medical chart via a display.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to electronic medical records systems and more specifically to a system wherein a plurality of separate entities maintain separate electronic medical records systems, wherein the entities can establish trusted relationships wherein trusted subset entities automatically obtain each others patient medical data as patients move among the trusted subset entities as if the data is owned and managed by each of the trusted subset entities and, in at least some cases, so that updates to data at one of the entities are automatically used to modify the data at the other of the trusted subset entities.

2. Description of the Related Art

Hereinafter various concepts will be described in the context of the medical industry. Nevertheless, it should be appreciated that the concepts herein may be applied in other non-medical industries. Hereinafter, unless indicated otherwise, the term “physician” will be used to refer to any employee or agent of a medical facility including but not limited to doctors, nurses, clinicians, technicians, other users, etc., that may have a need to access patient medical records in an electronic medical records system.

Modern medical entities or organizations generate huge amounts of patient-related data (hereinafter “patient data”) and the amount of data generated by such entities is likely to increase exponentially in the foreseeable future given new procedures, medical equipment (e.g., imaging, test and therapy systems) diagnostic protocols, increasing specialization and increased ability to store vast amounts of data.

As in other industries, the medical industry has embraced electronic records systems, referred to in the medical industry as electronic medical records (EMR) systems, to store the large volume of patient data for subsequent access in the form of patient charts.

In the medical and health records industry, medical entities typically maintain their own private and independent EMR systems for several reasons. First, by maintaining their own EMR systems, medical entities believe that they have better control of access to their patients' charts, which is necessary to comply with health records privacy laws. Second, by maintaining their own EMR systems, medical entities have the ability to review chart access and examine histories which can be useful in various ways including development of best practices, creating a more comprehensive and cohesive picture of a patient's course of treatment, auditing access to patient charts to control privacy and security, capturing information that can be analyzed to identify complex relationships between treatments and outcomes, etc. Third, by maintaining their own EMR systems, medical entities are able to customize system behaviors for specific applications and can also control data formats to ensure the ability to use archived data in these applications.

While separate EMR systems allow each entity the highest level of patient chart data control, such systems also have several shortcomings. One major shortcoming of separate EMR systems is that the separate systems result in barriers between physicians and patient data required to facilitate optimal patient services. For instance, in order to safely prescribe a medication for a patient, a physician needs to have complete access to various types of information including, for example, patient allergies, medications that the patient is currently taking (for contraindication purposes), a history of medications so that the physician can identify any medications that have already been used in an attempt

to treat or alleviate a condition etc. Where a patient receives medical services from a plurality of entities that maintain separate EMR systems, in many cases medication consumption and history information maintained by the separate entities is different because prescriptions originating in one system are not recorded in other systems. Thus, where a physician accesses only a single EMR system (i.e., the EMR system maintained by a facility/entity that the physician works at) to obtain medication information for a patient, often times the physician will only have access to incomplete medication information that specifies a subset of the medications that a patient is currently taking or has taken The physician does not have access to medication information in any other EMR systems and therefore may have incomplete information.

As another instance, it is important for a physician to know a patient's allergies when prescribing medications. As entities identify patient allergies, the entities record those allergies for subsequent use in their EMR systems but not in other EMR systems. Here again, where a physician accesses only a single EMR system to obtain allergy information for a first patient, the physician may only have access to an incomplete allergies list including a subset of a patient's allergies, even if a second entity has documented other allergies in a second EMR system maintained by the second entity.

As still one other instance, when a physician wants to schedule a subsequent follow up activity (e.g., an appointment with a specialist, an imaging session, etc.) for a patient, if the physician cannot access a patient's schedules in other EMR systems, the physician may schedule a duplicate therapy for the patient, book an appointment during a time slot that overlaps with another appointment for the patient or book an appointment that is out of sequence given other treatments that the patient is currently receiving or scheduled to receive. Moreover, with complete access to the patient's current appointments as recorded in separate EMR systems, the physician can schedule appointments with an eye toward patient convenience, thereby reducing the likelihood of skipped appointments. For example, where a first physician at a first entity has already booked some lab work for a specific time for a patient and a second physician at a second entity also intends to schedule other lab work, it would be desirable if all of the lab work could be scheduled together so that the patient could present for the lab work at a single appointed time. Without knowing schedule information from multiple EMR systems, it is essentially impossible for a scheduling physician to optimally schedule future activities for a patient.

One solution for sharing charts and/or scheduling information among different EMR systems has been to seek authorization from patients for sharing information among different entities that maintain different EMR systems and, when authorization is obtained at a first entity, to enable the patient to provide information to other entities that enable the other entities to manually request a patient chart from the first entity. For instance, where a primary care physician (PCP) located at a first facility associated with a first entity is going to refer a patient to a second physician (e.g., an arthritis specialist) located at a second facility associated with a second entity, during a patient visit to the PCP, the PCP may seek specific authorization from the patient to provide a patient chart to the second physician. Thereafter, when the patient arrives at the second facility for an appointment with the second physician, the patient can provide information (e.g., the name of the first facility or the PCP along with some proof of authorization, etc.) to the second physician that can be used to electronically manually request the PCP generated patient chart. This type of process where entities can manually request charts from other entities is referred to as a “pull type” information sharing process.

One other solution for sharing charts and/or scheduling information among different EMR systems has been to push information among different entities. For instance, in the above example where the patient has authorized her PCP to share her chart with a second physician at a second facility, the authorization may automatically cause the EMR system associated with the PCP's facility to transmit a chart to, or at least render a chart accessible by, the second physician at the second facility. One advantage here is that the second physician can access the patient chart prior to the patient arriving for the appointment with the second physician to prepare for the appointment. This type of process where entities push data to other entities is referred to as a “push type” information sharing process.

While the push and pull type information sharing processes described above are useful, these processes themselves have several shortcomings. First, in many cases patient charts and scheduling data may be located at several (e.g., five) different entities, and accessing all of the data associated with a patient that may be useful or required by a physician would require multiple patient authorizations as well as multiple manual requests by physicians, one request to each of the different entities. Multiple authorizations and requests are burdensome to both patients and physicians.

Second, simply accessing patient charts or scheduling data from two or more EMR systems does not cause the scheduling data from the two systems to be synchronized. For instance, when a first physician accesses allergy information from first and second separate EMR systems, after the allergy information has been viewed, neither of the EMR systems is updated to reflect the combined allergy information. For this reason, subsequent to accessing a complete set of allergy information for a patient, when a physician wants to access allergy information again for the patient, the physician has to take steps to manually access the allergy information again.

At least some systems allow physicians to manually accept allergy and other types of patient data from an EMR system for inclusion in a patient chart in another EMR system by selecting an ADD icon or the like presented within a patient chart. While this solution facilitates the option to update an EMR system with current information, the manual acceptance requirement is burdensome. In addition, even when a physician manually accepts data from a second EMR system for inclusion in a patient chart maintained by a first EMR system, that acceptance does not cause information unique to the patient's chart maintained by the first EMR system to be similarly updated in the patient's chart maintained by the second EMR system. For instance, assume that initially the first EMR system indicates that a first patient has two allergies A and B and the second EMR system indicates that the first patient had two allergies C and D. Here, manual acceptance of the differences in the allergy information in the first system would result in a complete allergies list including A through D in the first EMR system but the second system allergy information would not be updated (i.e., the second EMR system would still indicate only allergies C and D). A separate manual process in the second EMR system would be required to add allergies A and B to the second EMR system information for the patient.

Third, in many cases, when patient charts or schedule data is obtained from first and second different EMR systems, the charts/data are presented to a physician as separate information sets which makes it cumbersome to locate, view and comprehend all relevant information. For instance, where a physician associated with a first entity accesses all allergies for a first patient stored on first and second separate EMR systems, the allergy information is presented in first and second separate charts as opposed to as an integrated set of allergy information. In fact, in the present example, when first and second charts from first and second separate EMR systems are presented, they are typically presented in separate data screens or views requiring a physician to switch back and forth among the shots to view the entire allergies list, which is time-consuming and potentially confusing as a physician attempts to reconcile differences between the two lists. The problem of separate chart views is exacerbated when a physician accesses patient data from more than two separate EMR systems as movement and reconciliation is required among several different screens. Similar problems occur when scheduling information is accessed from separate EMR systems as the different schedules are not integrated and instead are presented as multiple different views.

Fourth, push and pull chart sharing processes between separate entities that call for transmission of large and detailed patient charts can require several minutes to complete. If these sharing processes were seldom required, several minute durations would not be particularly burdensome. Unfortunately, chart sharing and schedule sharing processes are commonplace and will likely increase in the future and execution time delay will become more annoying to system users.

Fifth, patient authorization for entities to share data are typically for relatively short periods of time (e.g., one month or one visit) and/or usually authorize only limited sharing of data. For this reason, often multiple patient authorizations are required for sharing among two entities which is annoying to many patients and which can slow down the process of patient care.

One other data sharing solution is based on a centralized exchange model wherein all pOarticipating health care entities push their data to a single central repository and then data is pushed from the central repository to an entity or is pulled by an entity from the repository as needed. One problem with the centralized exchange model is that it requires a large and often times expensive centralized infrastructure including servers, systems, administrators, etc. Another problem with the centralized exchange model is that centralized exchange data is often times not well maintained since physicians are not directly using these systems.

Some separate medical institutions have formed affiliations in an effort to provide more comprehensive medical services to patients and to reduce overhead costs. For instance, four hospitals and two clinics in a geographic region may form an affiliation so that patients can more readily take advantage of resources offered by all six institutions and administrative staff may be cut in order to reduce costs. Here, in some cases, large medical institutions that become affiliated all adopt a single EMR system so that the institutions can each access comprehensive data including patient chart data generated by all of the affiliated institutions. In many other cases, upon affiliation, each separate institution already has a legacy EMR system and moving to a single EMR system is considered cost prohibitive. In known cases where affiliated entities maintain separate EMR systems, patient chart access occurs as if the entities were unaffiliated. In other words, when a physician at one of the affiliated institutions wants to view patient chart data, the physician has to manually generate a separate query to each of the affiliated institutions and when patient charts are presented to the physician, the charts are presented as separate charts. Thus, accessing all patient charts from all affiliated institutions is time consuming and the end result, separate charts, is cumbersome to comprehend and use. In addition, in known cases where affiliated entities maintain separate EMR systems, access to charts maintained by different entities does not result in a combining of data into a single EMR system so that when full chart data is again required, separate patient charts have to again be obtained from each affiliated entity.

### BRIEF SUMMARY OF THE INVENTION

While patients routinely receive medical services from many different entities where each of the entities maintains its own EMR system, in many cases physicians associated with a first entity end up, when referring patients to other physicians outside of or not affiliated with the first entity, referring most of their patients to a small subset of other, typically geographically proximate, entities. For instance, in many cases it is common for 80% or more of inter-entity referrals to be among a small number (e.g., six) of separate entities, each of the separate entities routinely referring patients to others in the group.

In this environment where a small group of entities routinely provide services to the same patients, it has been recognized that the problems described above that are associated with separate entities maintaining separate EMR systems can be overcome by establishing a special trusted partners relationship between entities wherein physicians working through one of the entities automatically obtain patient data initially generated by other entities in the partnership. Thus, for instance, when a physician initially requests a patient chart from one trusted partner subset entity, the query results in an automatic collecting of patient chart data from all other entities in the trusted partnership so that the physician need not manually request the patient charts from the other trusted subset entities.

In addition, in at least some cases, after the trusted partnership is established between a set of entities, when changes are made to data in an EMR system associated with one of the trusted subset entities, the changes are used to automatically update the other trusted subset entity EMR systems. Here, in at least some cases, patient chart data will include first and second different subsets and the automatic synchronization is only performed for the first data subset. In some cases the first data subset includes decision support data which is routinely used by physicians to make medical decisions for patients while the second data set includes other less routinely consulted data. What constitutes “decision support” data may be different in different systems. This automatic synchronization increases the speed with which a physician can access patient chart data that is initially generated by a plurality of entities that each maintain separate EMR systems in two ways. First, the physician need not query each separate EMR system for patient data. Second, because decision support data is automatically synchronized, access to the most important patient chart data from all of the trusted subset entities can be accessed at any one of the trusted subset entities without further access to the entities that initially generated the data.

The fact that trusted subset entities are already routinely referring patients among themselves reflects an existing high level of confidence or trust among the subset entities which should minimize concerns about automatically sharing of patient chart and scheduling data. When data is to be obtained from entities outside the trusted subset, a manual sharing process whereby physicians manually issue electronic requests to source entities would be required.

Where decision support data is automatically synchronized within patient data that is used to generate patient medical charts at all of the trusted subset entities, after synchronization, by using the synchronized data maintained by a single entity to generate a patient chart, the resulting unified chart includes data for a patient that was initially generated by the entire trusted subset of entities. Thus, for instance, where the decision support data includes lists of a patient's allergies, where a first trusted subset entity's allergies list includes allergies A, B and C, a second trusted subset entity's allergies list includes allergies A, D, E and F and a third trusted subset entity's allergies list includes allergies F, G, H and I, upon synchronization, all of the first, second and third entities allergies lists would include allergies A through I. In this case, after synchronization, when the first entity's allergies list A through I is used to generate a patient chart, the allergies list will include A through I even though many of the allergies on the combined list were first registered at the second and third entities. This unified chart is far easier to use than the multiple charts that result from prior known systems.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic illustrating an exemplary information/communication system that is consistent with at least some embodiments of the present invention;

FIG. 2 is a schematic illustrating an exemplary EMR system that may be included in the system of claim 1;

FIG. 3 is a schematic illustrating an exemplary trusted partners database like the ones shown in FIG. 1;

FIG. 4 is a schematic illustrating an exemplary patient authorization database like the ones shown in FIG. 1;

FIG. 5 is a schematic illustrating a second exemplary patient authorization database that is similar to the database shown in FIG. 4, albeit maintained by a different one of the entities shown in FIG. 1;

FIG. 6 is a schematic illustrating the database shown in FIG. 4, albeit at a different point in time;

FIG. 7 is a flow chart illustrating a method for obtaining patient authorization to share patient chart information among trusted partner entities;

FIG. 8 is a flow chart illustrating a process performed by an entity shown in FIG. 1 for obtaining patient chart data from multiple trusted partner entities for presentation to a physician an initial time a request for a specific patient chart is generated and thereafter;

FIG. 9 is a flow chart illustrating a process performed by each of the entities shown in FIG. 1 for receiving and processing patient chart requests from other trusted partner entities;

FIG. 10 is a flow chart illustrating a process performed by each of the trusted partner entities shown in FIG. 1 for automatically updating and synchronizing portions of a patient's chart amongst trusted partners shown in FIG. 1 subsequent to an initial request for a patient's chart in a push type trusted partners system;

FIG. 11 is a flow chart similar to FIG. 10, albeit showing the process in a pull type trusted partners system;

FIG. 12 is a flow chart illustrating a process for updating data received by trusted partners from trusted partners in FIG. 1 in a push type partners system;

FIG. 13 is similar to FIG. 12, albeit showing the process in a push type trusted partners system; and

FIG. 14 is a flowchart illustrating a sub-process that may be substituted for a portion of the process shown in FIG. 8 where patient data is automatically obtained from trusted subset entity EMR systems upon initial registration at one of the trusted subset entities.

### DETAILED DESCRIPTION OF THE INVENTION

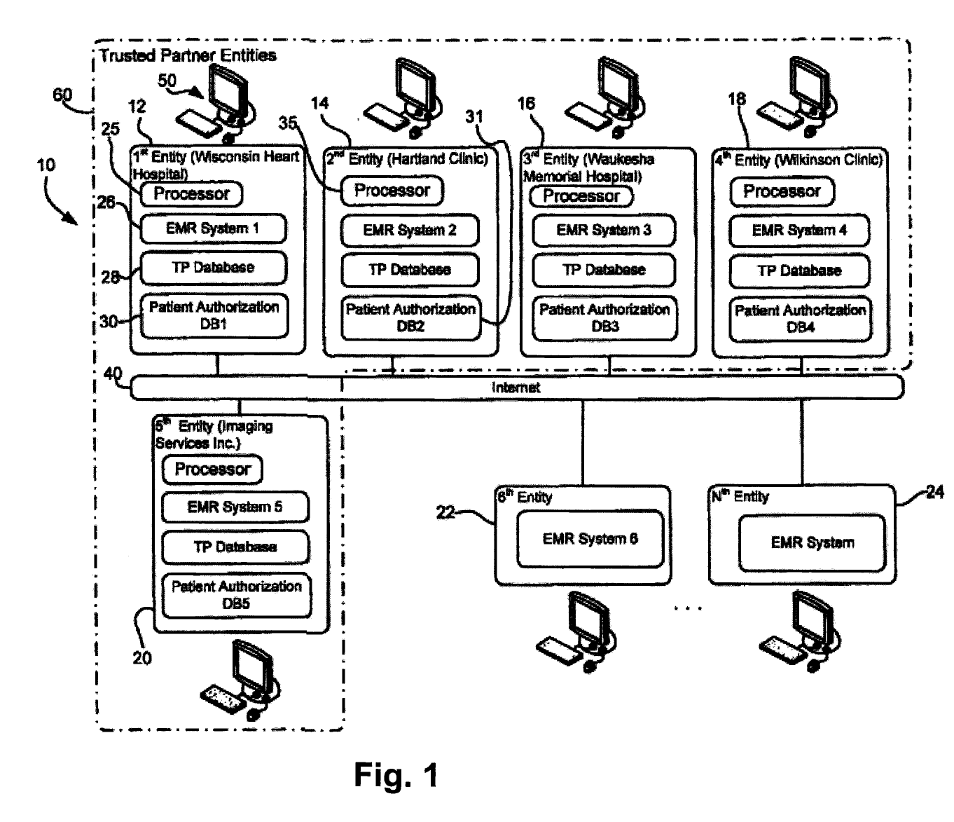

Referring now to the drawings wherein like reference numerals correspond to similar elements through the several views and, more specifically, referring to FIG. 1, the present invention will be described in the context of exemplary information and communication system 10 that includes, among other things, a plurality of different entities 12, 14, 16, 18, 20, 22 and 24, that are each linked to a communication network such as the internet 40 that enables communication between the separate entities. Each of the exemplary entities 12-24 represents a separate medical facility. For example, the first entity 12 represents Wisconsin Heart Hospital and the second through fifth entities, 14, 16, 18 and 20 represent Hartland Clinic, Waukesha Memorial Hospital, Wilkinson Clinic and Imaging Services Inc., respectively. While each of the exemplary entities only represents a single medical facility, it should be appreciated that some entities may represent more than one facility where the entity facilities employ the same electronic medical records (EMR) system. Each of the entities 12-24 has similar characteristics and operates in a similar fashion and therefore, in the interest of simplifying this explanation, only entity 12 will be described here in detail.

Referring still to FIG. 1, exemplary entity 12 includes a first EMR system 26, a plurality of data access terminals 50 (only one shown), computing hardware represented by a processor 25 for storing EMR data, programs, and databases 28 and 30 described hereafter. Although entity hardware is represented simply by processor 25, it should be appreciated that the hardware may include one or more servers as well as other components including intranet communication devices, database storage devices, etc. Each of the terminals 50 may include a desktop type PC or laptop computer or a portable computer of some type including but not limited to a laptop, a personal digital assistant, a smart phone, etc. Each of the terminals 50 can be used to access patient charts, scheduling information and/or other patient related data stored by the EMR system associated therewith. Each of the terminals may be locally located at one of the entity facilities or may be used to patch into the facility system from remote locations (e.g., a physician's home).

Referring still to FIG. 1, in some embodiments the EMR systems maintained by the separate entities 12 through 24 may be the same system types provided by the same vendor (e.g., Epic or Cerner, etc.) so that chart data, scheduling data and other data stored therein has essentially the same form throughout all of the EMR systems. In this case, data sharing among the separate EMR systems is relatively simple because the data maintained by the separate EMR systems has similar formats. In other embodiments one or more of the EMR systems associated with entities 12 through 24 may be of a different type (e.g., vended by a different vendor) than the other EMR systems so that data stored in the EMR systems has different forms that are not directly compatible. In this case, prior to transmitting data between entities, an intermediate module may convert the data into some universal format such as XML which can then be converted back to a format suitable for use by a receiving EMR system at the receiving end of the transmission. Thus, the present concepts should operate irrespective of whether or not the EMR systems are of the same type.

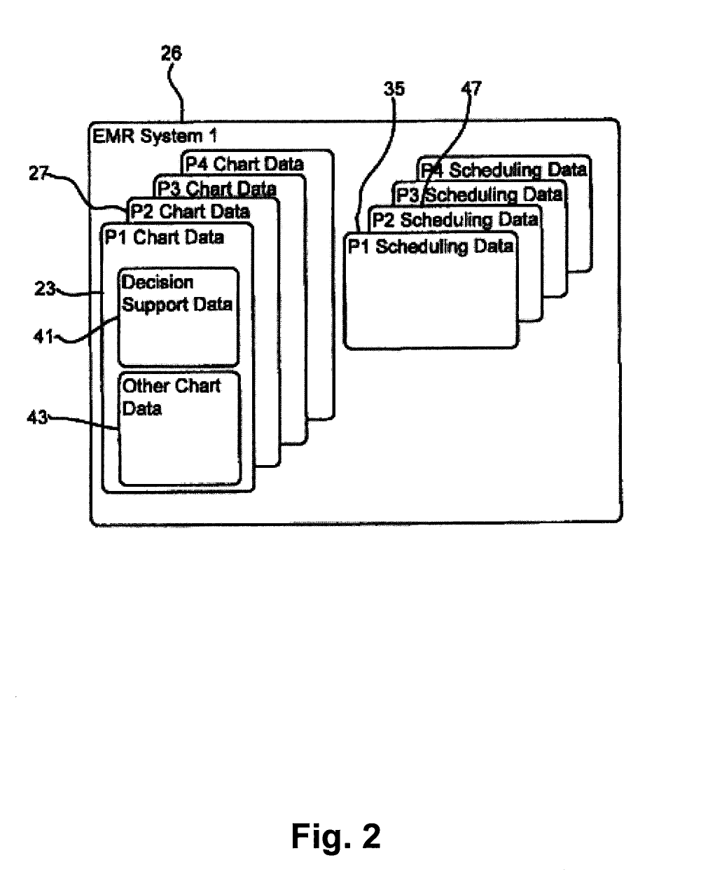

Referring to FIG. 2, first EMR system 26 maintains patient data 23, 27, etc., for generating patient charts and patient scheduling information 45, 47, etc., for all patients and all patient related activities that take place at the first entity 12. The patient chart data is similar for each patient and therefore, in the interest of simplifying this explanation, only patient chart data 23 for patient P1 will be described here in any detail. Exemplary patient chart data 23 for patient P1 includes decision supporting data 41 and other chart data 43. The decision support data 41 includes types of data that physicians routinely consider when making medical decisions. For instance, decision support data may include current and past medications, patient allergies, immunizations, test and lab results, family medical histories, etc. Other chart data 43 includes all chart data other than the decision support data and generally includes data that is not routinely used by physicians to support medical decisions. Thus, in at least some embodiments, patient chart data includes first and second data subsets 41 and 43. The chart data 23, as the label implies, is used by patient chart software to generate a patient medical chart for patient P1 when requested by a physician. While the chart data 23 may include a large number of different data types, the decision support data 41 typically includes only a relatively small fraction of the total patient chart data 23.

Exemplary scheduling data 35 for patient P1 includes data indicating currently scheduled medical activities for patient P1 including procedures, appointments, tests, therapy sessions, imaging sessions, etc. The scheduling data is used by scheduling software to instantiate scheduling views for an associated patient via a display screen (see terminal 50 in FIG. 1). The scheduling data 45 like the decision support data 41, is routinely consulted by physicians (or schedulers) when planning medical activities for a patient. Thus, the chart and scheduling data may be generally divided into first and second data subsets where the first subset includes routinely consulted data (i.e., decision support data and scheduling data) and the second subset includes all other patient chart data that is not routinely consulted.

In at least some embodiments, the first data subset may further include any non-clinical data relevant to patient care including but not limited to billing data, insurance information, demographics, preferences, operational data, etc. The general idea here is that patient data can be divided into two separate sub-sets.

Referring still to FIG. 1, a subset of entities 12-24 is shown as forming a trusted partners subset 60 where the subset includes first through fifth entities 12, 14, 16, 18 and 20, respectively. The phrase “trusted partners” refers to entities that have formed a special trusted partner relationship whereby each entity in the trusted subset automatically obtains patient chart and scheduling data initially generated by other trusted subset entities after patient authorization has occurred and without requiring a separate manual request to each of the trusted subset entities and where changes to at least a subset of patient chart data that occur at any one of the entities is automatically used to update patient chart data maintained by the other trusted subset entities without requiring manual authorization.

In at least some embodiments, only the first data subsets (i.e., data routinely used to make medical decisions for patients, (e.g., decision support data and scheduling data)) are synchronized among trusted subset entity EMR systems. By facilitating automatic access to all trusted subset entity patient chart data and automatic updates of first data subsets among the subset entities, important patient chart data initially generated by any of the trusted subset entities can be accessed more rapidly (i.e., without requiring separate manual requests to each trusted subset entity and without requiring searching remote entities each time patient data is sought). In addition, the burden on physicians to issue separate chart requests to each trusted subset entity is eliminated.

Moreover, where first data subset changes made through trusted subset entities are used to automatically update patient chart data throughout the trusted subset, a single or unified patient chart can be generated using data maintained by any one of the trusted subset entities for a patient that includes decision support data and/or scheduling data initially generated by any of the trusted subset entities. The unified patient chart view and/or scheduling view makes it much easier for a physician to view and understand chart or scheduling data presented. In this regard, instead of requiring a physician to examine multiple separate patient charts views or scheduling views on separate display screens for a patient (i.e., one view generated for each EMR system that maintains data for the patient), a single chart view or scheduling view with combined data is presented.

The trusted partners relationship should be contrasted with the case where affiliated institutions all maintain separate EMR systems where physicians can manually access patient charts maintained by the separate entities. In the case of affiliated institutions, access to patient charts maintained by the separate EMR systems maintained by the affiliated institutions is not automatic, data modifications are not automatically shared among the separate EMR systems and a single unified patient chart including data initially generated at all of the affiliated institutions is not generated.

Referring again to FIG. 1, because of the trusted partnership relationship, where the first and second entities 12 and 14 maintain separate first and second patient charts for a first patient, because entities 12 and 14 are trusted partners, a physician using a terminal 50 associated with entity 12 is able to obtain patient chart data initially generated by second entity 14 in addition to accessing patient chart data for the first patient maintained by entity 12. Similarly, a physician using a terminal associated with second entity 14 is able to obtain patient chart data for the first patient initially generated by either of entities 12 or 14. As yet one other example, because the fifth entity 20 is a trusted partner with each of the first through fourth entities 12, 14, 16 and 18, a physician using a terminal associated with fifth entity 20 is able to access patient chart data initially generated by any of entities 12, 14, 16 and 18 as well as by the fifth entity 20. In FIG. 1, entities 22 through 24 are not included in the trusted partner subset 60 and therefore physicians operating through entities 22 or 24 can only access patient chart information maintained by other entities 22 and 24 via some other process other than the trusted partner process described herein. Similarly, because entities 22 and 24 are outside the trusted subset 60, a physician working through one of entities 12 through 20 must use some other process instead of the automated trusted partner process to access patient chart and/or scheduling data maintained by either of entities 22 or 24. For instance, a manual data request process like those described above may be performed via one of the subset 60 entities to access data maintained by one of non-trusted entities 22 and 24.

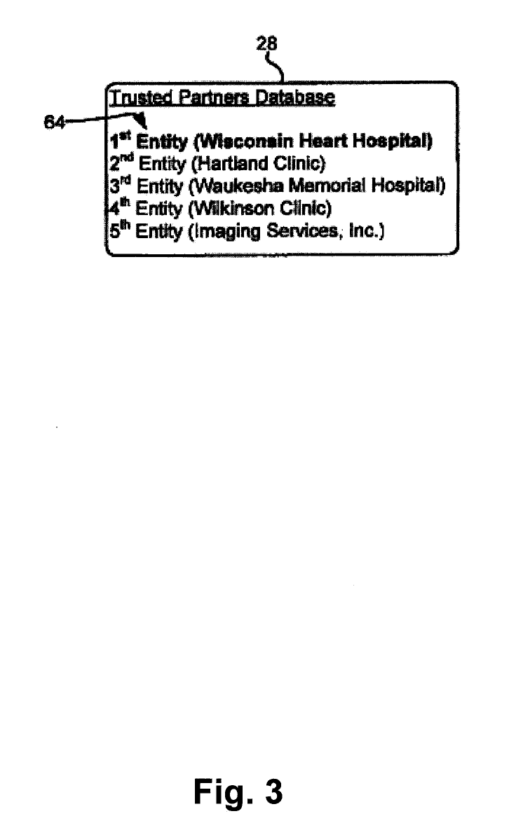

Referring yet again to FIG. 1, to facilitate the trusted partner relationship, each of the trusted partner entities 12, 14, 16, 18 and 20 maintains a trusted partners database (see 28 corresponding to first entity 12 in FIG. 1). Referring to FIG. 3, an exemplary trusted partners database 26 that is consistent with system 10 shown in FIG. 1 is illustrated. The trusted partners database 26 includes a list 64 of trusted partner entities. In the present example, the list 64 includes the first through fifth entities illustrated in FIG. 1 and does not include the other entities 22 or 24 which are not trusted partners. While the partners subset is shown as a list, it should be appreciated that in most cases the list would include more than just partner identifiers. For instance, in at least some cases, for each partner subset entity, the list would include information indicating how to link to the partner for communication purposes as well as security information to ensure a secure link to the partner, etc. In at least some embodiments all trusted partners databases for entities in a trusted partners subset are identical.

In at least some cases, it is contemplated that even though entities may form trusted partnerships, some patients may not want to share their patient chart data among all of the different entities in a trusted subset. For example, in the case shown in FIG. 1 where the first through fifth entities 12, 14, 16, 18 and 20 have formed a trusted partnership, a patient may only want his patient chart data or scheduling data shared amongst the first, second and fifth entities 12, 14 and 20, respectively, and may not want his chart data or scheduling data automatically shared with the third and fourth entities 16 and 18. Referring again to FIG. 1, to enable patients to override trusted partner relationships, in at least some embodiments of the present disclosure, each entity in a trusted partners subset maintains a patient authorization database. In FIG. 1, exemplary first and second patient authorization databases are labels 30 and 31 and correspond to entities 12 and 14, respectively.

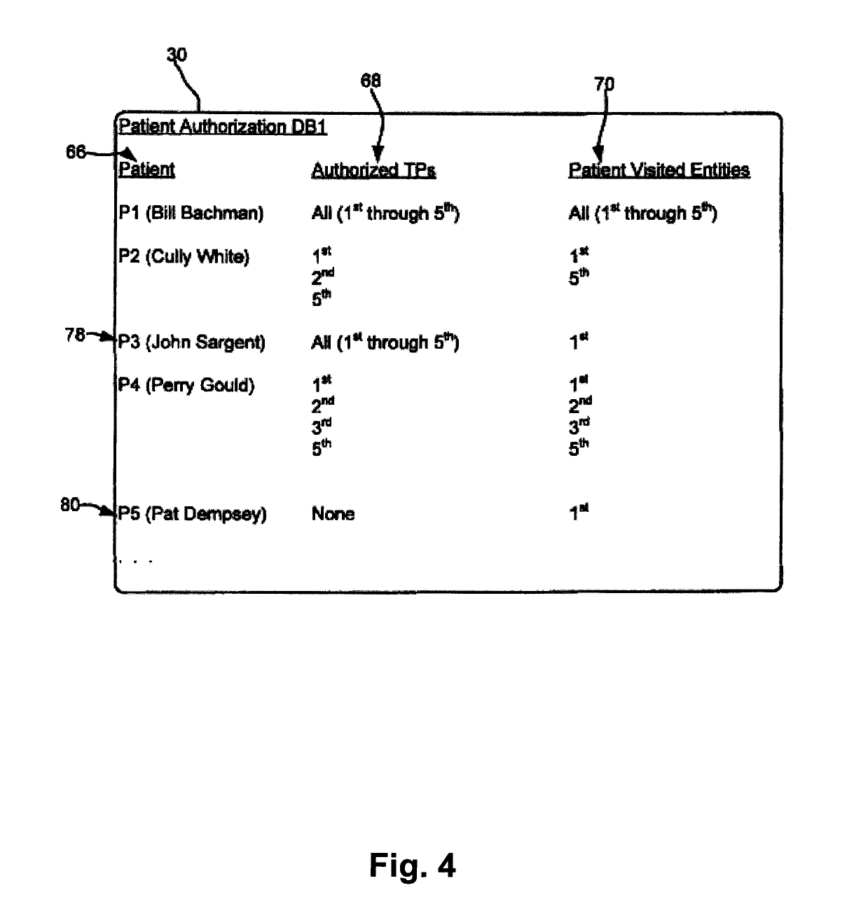

Referring also to FIG. 4, an exemplary first patient authorization database 30 is shown. While database 30 is shown in a simplified table format in order to simplify this explanation, it should be appreciated that database 30 may take any of several different forms and would likely be more complex in a working system. Database 30 includes a list of first entity patients in a first column 66 including exemplary patients P1-P5. A second table column 68 includes a separate list of authorized trusted partners for each one of the patients in column 66. For example, for a first patient P1, Bill Bachman, all of the trusted partners in the subset 60 (see again FIG. 1) are listed as authorized trusted partners meaning that the first patient has authorized the trusted partners to share patient chart information for the first patient amongst all of the entities in the trusted partners subset.

For the second patient P2, Cully White, the authorized trusted partners list in column 68 includes only three of the five trusted partners including the first, second and fifth trusted partners. Thus, the second patient P2 has only authorized the first, second and fifth entities in the trusted partner subset 60 to share patient chart information for the second patient amongst themselves and has not authorized sharing of the patient chart data with the third and fourth trusted partners in subset 60. In FIG. 3, the third patient P3 has authorized sharing of chart data among all five trusted partners in subset 60 and the fourth patient P4 has authorized sharing of chart data among the first, second, third and fifth entities in the subset 60. Exemplary fifth patient P5, Pat Dempsey, has not authorized any sharing of chart data amongst the trusted partners and therefore a “none” designation is shown in column 68 corresponding to patient P5.

As indicated above, at least the first data subset of patient data including chart and/or scheduling data may be synchronized among the partner entities in order to expedite chart and/or scheduling access for physicians working at associated entities. For example, decision support data 41 (see FIG. 2) may be synchronized among patient chart data maintained by all trusted partner entities authorized to share data by particular patients while other data 43 (see FIG. 2) that is not decision supporting is accessible but not synchronized automatically. Thus, for example, referring again to FIG. 4, when a second patient P2 has authorized sharing among the first, second and fifth trusted partners, if patient P2 is visiting the first entity and a physician at the first entity prescribes a medication A for the second patient P2, in addition to adding the prescribed medication to the patient chart maintained by the first EMR system 26, a medication A identifier is automatically made available to each of the other authorized trusted partner entities including the second and fifth entities. Similarly, scheduling data (see 45 in FIG. 2) may be synchronized among authorized trusted partners to expedite the process of accessing patient scheduling information. Thus, here, a subset of relatively important and routinely accessed patient data can be pushed to authorized trusted partners to expedite access while avoiding the requirement to synchronize all information amongst the EMR systems maintained by the separate trusted partner entities. In short, the system described here is “data aware” so that important data types are automatically shared or synchronized among trusted partners to expedite information processes and other data is only rendered accessible.

It has been recognized that, despite the fact that a trusted partner entity has been authorized to share patient chart information by a patient with other trusted partners in a subset, unless a patient has visited an entity, there is no reason for that entity to maintain a patient chart or any patient information for the particular patient. Here, by limiting synchronization of patient data to only the subset of trusted subset entities visited by a patient, the synchronization process can be simplified. Thus, in at least some embodiments of the present disclosure, the patient authorization databases associated with entities visited by a patient each maintains a list of patient visited entities (PVEs) for each of the patients listed in column 66. To this end, see again FIG. 4 where a third column 70 is labeled patient visited entities (PVE) and includes a list of entities visited for each of the patients in column 66. As seen, the exemplary PVE list for patient P1 includes all five trusted partners in subset 60 (see again FIG. 1). For second patient P2, the PVE list in column 70 includes only the first and fifth entities. For the fifth patient P5, the PVEs include only the first entity as patient P5 has not visited any of the other entities in the partner subset 60.

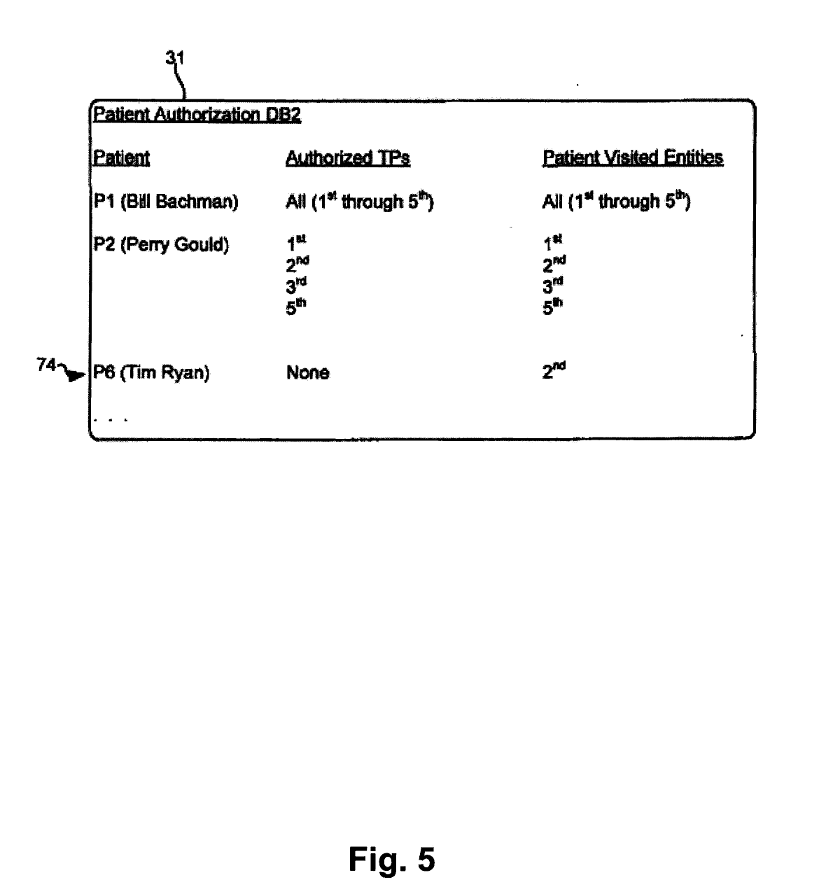

Referring now to FIG. 5, the exemplary authorization database 31 maintained by second entity 14 in FIG. 1 is illustrated in greater detail. It should be appreciated that database 31 stores a set of data that is distinct from the data in database 30 (see again FIG. 3) despite the fact that entities 12 and 14 are both in trusted partners subset 60. The differences between databases 30 and 31 reflect the fact that different patient subsets have visited different trusted partner entities and that each entity only maintains patient authorization database data for patients that have visited the specific entity. In the exemplary case represented by FIGS. 4 and 5, second patient P2 only visited the first and fifth entities 12 and 20, respectively, and therefore patient authorization data for patient P2 appears in database 30 (see FIG. 4) but not in the second entity patient authorization database 31 (see FIG. 5). Similarly, a sixth patient P6, Tim Ryan, visited second entity 14 but not first entity 12 and therefore second entity patient authorization database 31 includes data for patient P6 while first entity patent authorization database 30 does not include patient P6 data.

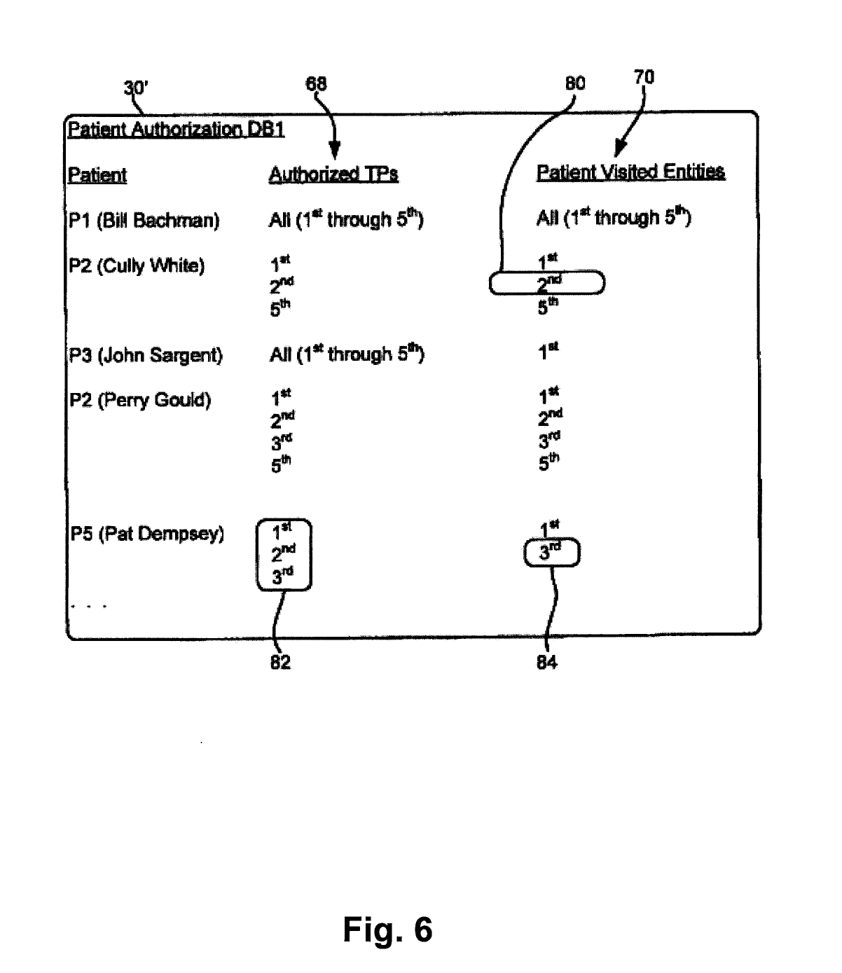

As patients visit different trusted partner entities and authorize more data sharing among the entities, the patient authorization databases are updated. To this end, see FIG. 6 that shows an exemplary database 30′ which corresponds to database 30 from FIG. 4 at a subsequent point in time. There are three distinctions between databases 30 and 30′. First, while patient P2 did not visit second entity 14 prior to a time corresponding to database 30, as shown at 80 in FIG. 5, patient P2 visited second entity 14 prior to the time associated with database 30′ and therefore the second entity 14 has been added to the PVE list associated with patient P2. Thus, while not shown in the figures, because the patient visited the second entity 14 and has, as shown in column 68 of FIG. 6, authorized data sharing among the first, second and fifth entities, the second entity patient chart would mirror at least subsets of patient data (e.g., decision support data) maintained by the second and fifth entities. In addition, because of the trusted partnership and authorization by the second patient P2, a physician accessing the second patient's chart via the second entity would have the ability to access other non-synchronized second patient chart data maintained by any of the first, second and fifth entities.

Second, comparing databases 30 and 30′, it can be seen that fifth patient P5 visited the third entity 16 (see again FIG. 1) between the times associated with databases 30 and 30′ as indicated at 84.

Third, as indicated at 82, fifth patient P5 authorized trusted partner sharing among the first through third entities 12, 14, 16 between the times associated with databases 30 and 30′. Here, for instance, while patient P5 was visiting the third entity 16, patient P5 may have been asked to authorize trusted partner data sharing generally at which time the patient may have authorized the first through third subset. Alternatively, fifth patient P5 may have authorized sharing of the first through third subset via a visit to the first entity 12 prior to an initial visit to the third entity.

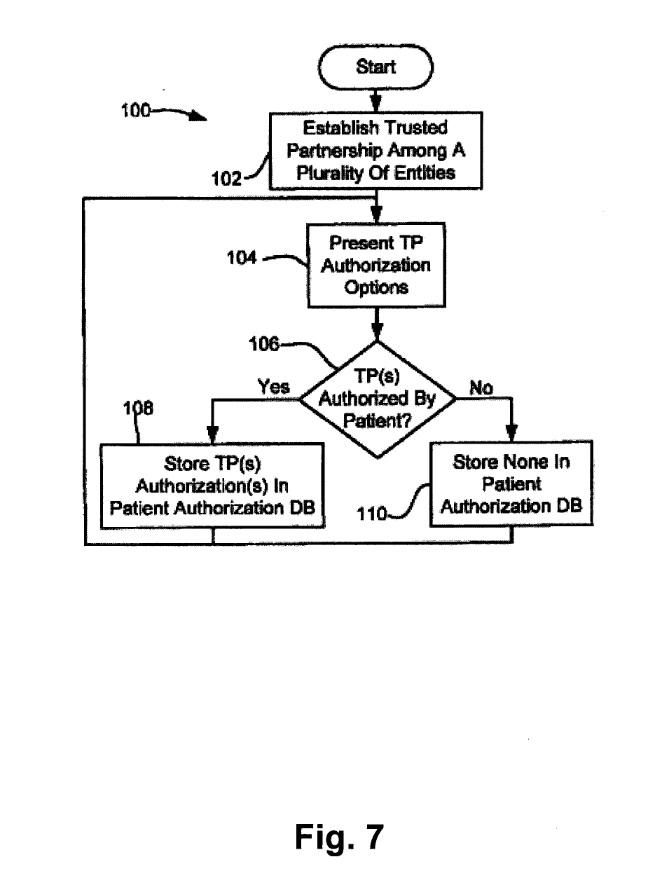

Referring now to FIG. 7, a process 100 that may be performed using one of the terminals 50 shown in FIG. 1 for obtaining patient authorization to share patient chart data among trusted partners is illustrated. Hereinafter, unless indicated otherwise, it will be assumed that the processes described are performed via a terminal 50 associated with first entity 12 in FIG. 1 in conjunction with the first entity processor 25. It will also be assumed that after authorized trusted partner entities have been visited by a patient, each visited partner entity maintains a chart for the patient and that the visited authorized partner entities automatically synchronize at least a first data subset including decision support data (see 41 in FIG. 2) as well as scheduling data (see 45 in FIG. 2) among themselves.

In FIG. 7, at block 102, a trusted partnership is established among a plurality of entities that includes two or more entities. Establishing a trusted partnership may include a legal procedure whereby separate entities execute agreements specifying how types of data are to be accessible among the entities and types of data (e.g., decision support data, scheduling data, etc.) to be automatically synchronized between the partner entities. After a trusted partnership has been legally established, the trusted partnership database 28 (see FIG. 2) is generated and is stored by each of the trusted entities as shown in FIG. 1.

After a trusted partners subset has been established, additional entities may be added to the partnership through a mutual consent process after which new entities would be added to the trusted partner database. Where new entities are added to the partner subset, an additional authorization process similar to the process shown in FIG. 7 would be required. For instance, where sixth entity 22 (see again FIG. 1) is added to subset 60, the next time a patient visits any of the entities 12 through 22, patient authorization to share data between sixth entity 22 and the other subset entities for the specific patient would be sought.

In at least some embodiments, entities may be removed from a trusted partner subset. Where a partner subset entity is removed, in at least some embodiments, notice is provided to patients affected by the removal in an attempt to avoid a case where a patient believes entities are automatically sharing data amongst themselves when in fact they are not. For instance, in FIG. 1, if entity 16 is removed from subset 60, the next time or times any patient that has authorized sharing among entity 16 and other subset 60 entities visits any one of the entities 12 through 20, upon registration for an appointment, notice may be provided to the patient and or physician that entity 16 is no longer part of the trusted partnership signaling that it should not be assumed that data is shared among entity 16 and the previous partners. Here, if the patient knows that entity 16 may have recent patient data, some process other than the trusted partners process may be performed to access data maintained by entity 16 if necessary. Patient notice may be provided during a physician visit either via the physician or via an e-mail or the like to the patient.

Referring again to FIG. 7, after the trusted partnership is established, when a patient arrives for the first time for an appointment at one of the trusted partner entities in the subset 60, the patient goes through a registration process where, among other things, the patient is requested to authorize sharing of patient data (e.g., chart and scheduling data) amongst the trusted partners in the subset 60. This process of seeking authorization at block 104 may be aided by a receptionist or may be performed by the patient using a kiosk or the like to facilitate registration. In either case, the patient may be required to perform some affirmative steps such as signing a screen via an electronic pen, signing a printed out document which is then scanned in and digitally saved, or the like.

In at least some embodiments of this disclosure, where the partner subset 60 includes more than two partners, the authorization step may allow a patient to select all or a subset of the entities to be included in the trusted partnership for the patient. In addition, in at least some embodiments, a patient will be presented the option to reject authorization to share with trusted partners. At block 106, where the patient authorizes one or more trusted partners for sharing patient data, control passes to block 108 where the trusted partner authorizations are stored in the patient authorization database (see again FIG. 4, column 68). At block 106, where the patient does not authorize trusted partner sharing of patient data, control passes to block 110 where the system stores an indicator that no trusted partner entities have been authorized for sharing data for the patient. In addition, during this initial registration process, the system adds a first entity designator to the PVE list in column 70 (see FIG. 4) indicating that the first entity has been visited by the patient and therefore that the first entity thereafter maintains a patient chart for that particular patient.

Moreover, upon registration, a patient may be given the option to identify the time period during which authorization to share the patient data is valid. For instance, exemplary authorization periods may be six months, two years, etc., after which new authorizations would be required for future sharing. Subsequent to the process shown in FIG. 7, when a patient visits a trusted subset entity that has not been authorized to share patient data with other subset entities, a process similar to the process 100 of FIG. 7 is performed. Here, the subset entities currently authorized to share patient data may be identified for the patient along with a list of other trusted subset entities that are not authorized and the patient will be given the choice to authorize additional sharing. When additional subset entities are authorized to share, the patient authorization databases for each entity authorized to share and that is visited by the patient is updated.

While the disclosed system may be used to provide access to either or both of a patient chart or scheduling tools for scheduling patient activities, unless indicated otherwise hereafter, the exemplary processes will be described in the context of a patient chart request as opposed to a scheduling action. Nevertheless, it should be appreciated that a scheduling action would result in data sharing activities similar to those described below.

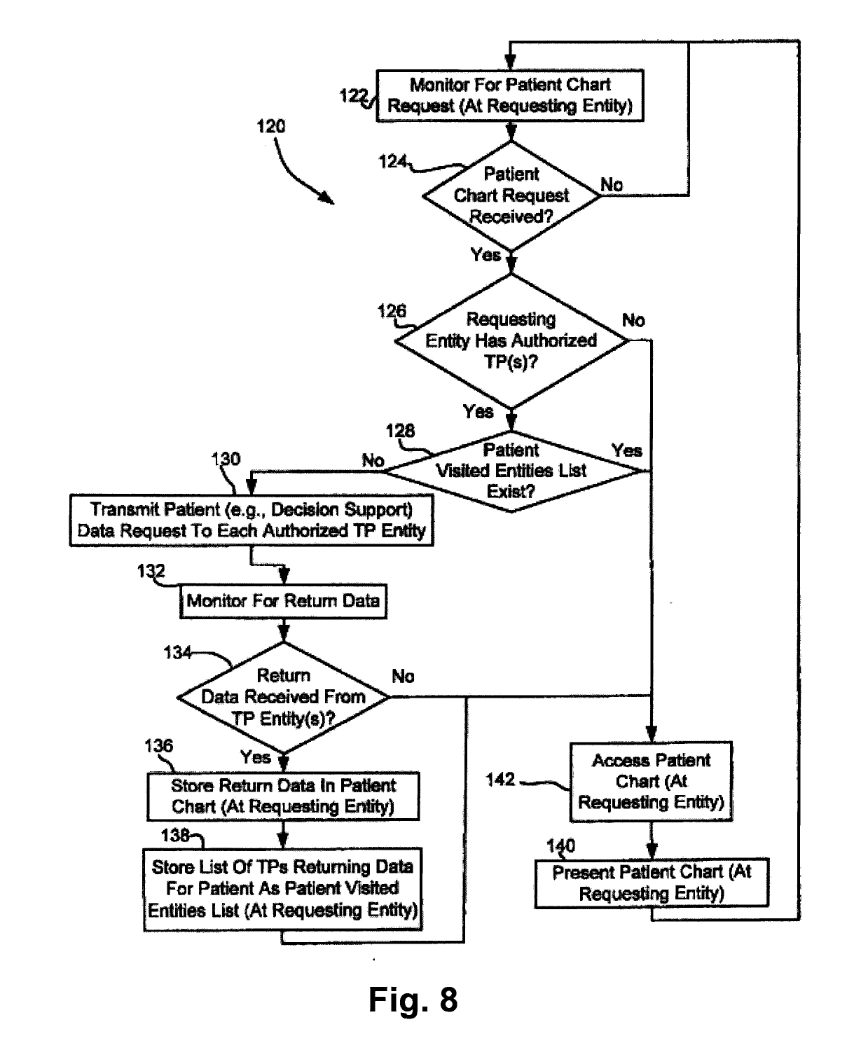

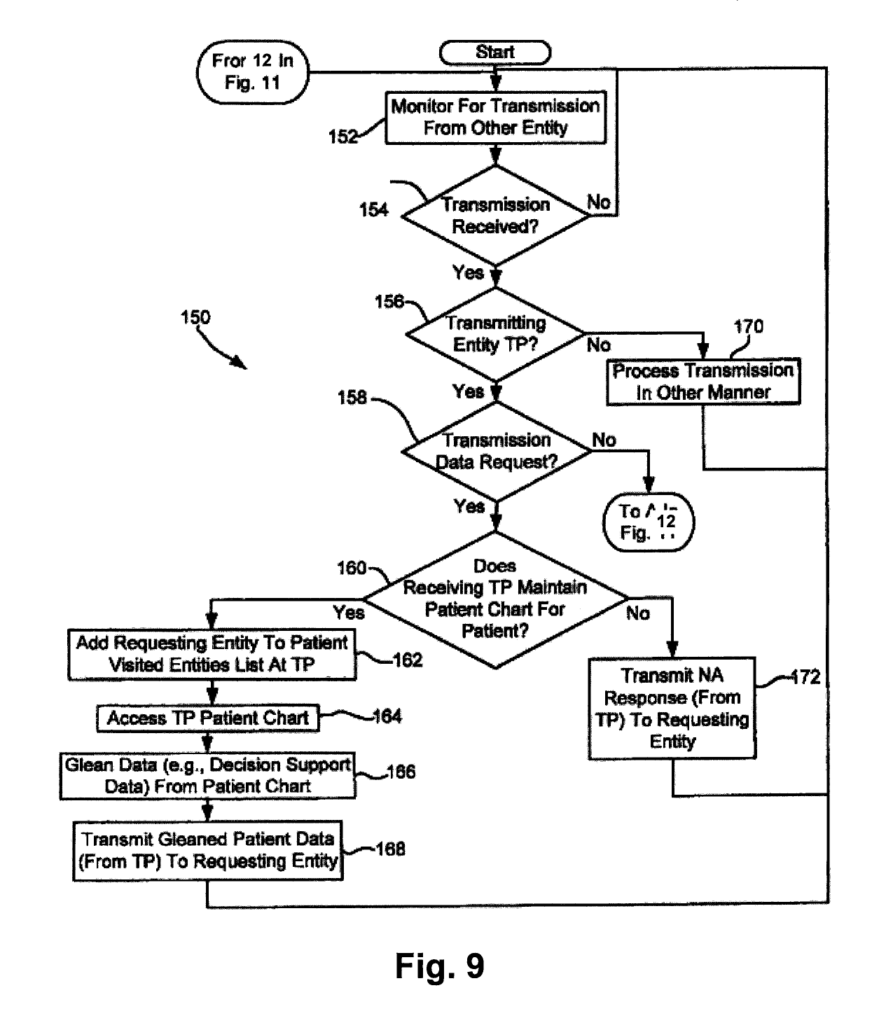

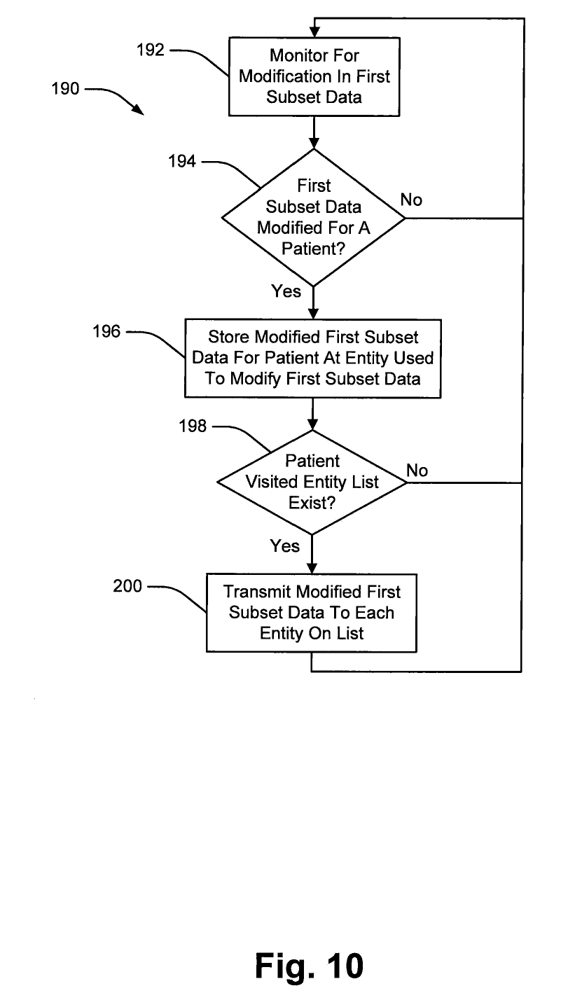

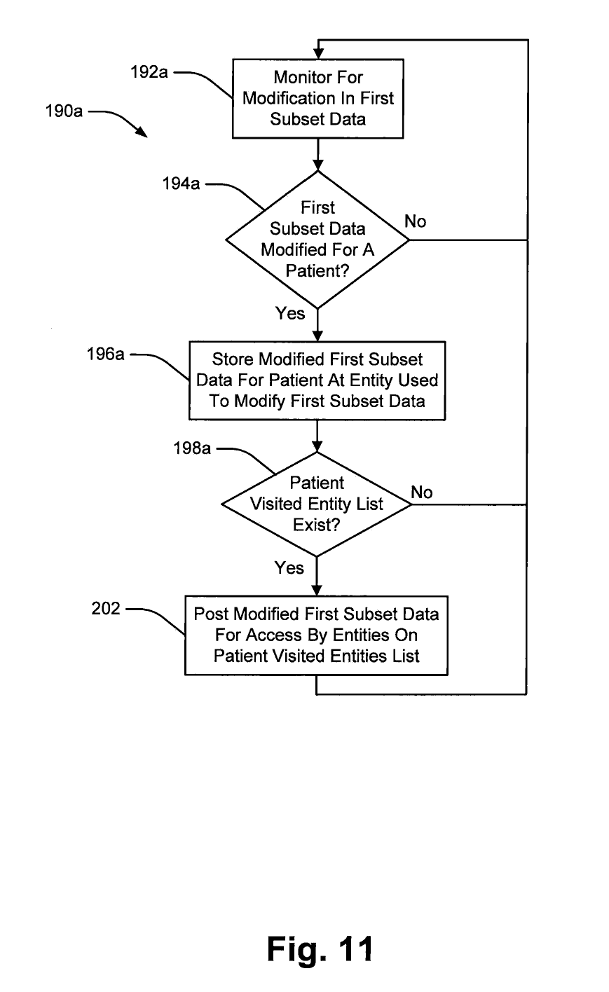

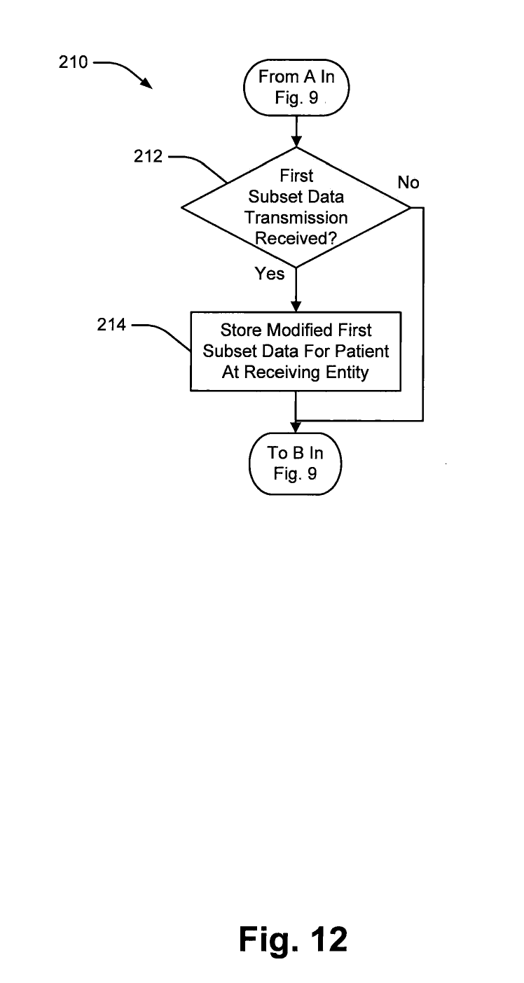

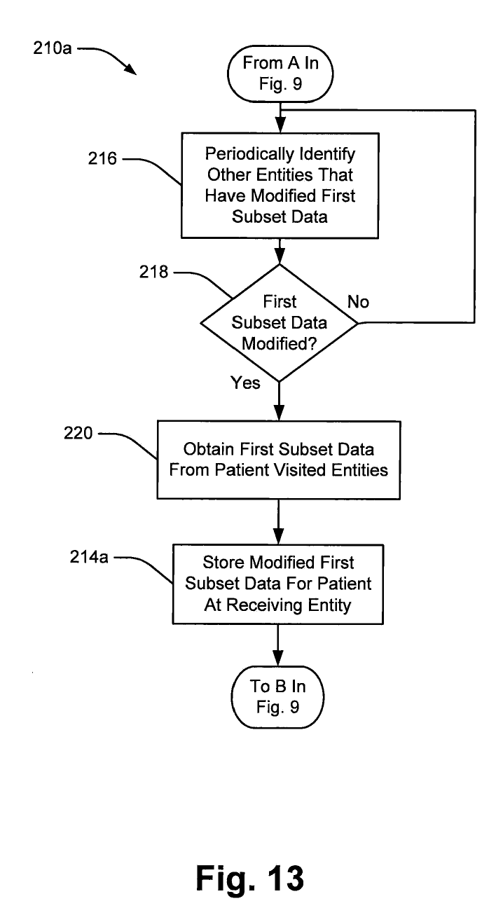

After registration, the FIG. 8 and FIG. 9 processes are performed when a physician attempts to access a chart for the registered patient a first time at the entity at which the registration occurred. After an initial attempt to access a patient's chart at an entity, the processes shown in FIGS. 10 and 11 (or the processes shown in FIGS. 12 and 13 in a push type system) are performed to automatically synchronize at least a subset of data amongst trusted partners essentially in real time as data is generated by the partners.

After registration, when the patient is seen by a physician at the first entity, the process 120 shown in FIG. 8 is performed to provide a patient chart to a physician. At block 122 the processor 25 monitors terminals 50 associated with the first entity 12 for patient chart requests. Hereafter, an entity used to generate a chart request will be referred to as a “requesting entity” unless indicated otherwise. At block 124, where a patient chart request is not received, control passes back up to block 122 where the monitoring process continues. Once a patient chart request is received at block 124, control passes to block 126 where processor 25 determines whether or not the requesting entity (e.g., in the present example the first entity) has any trusted partners. Step 126 is performed by accessing the patient authorization database 30 (see again FIGS. 1 and 4) to identify authorized trusted partners for the requesting entity. When a trusted entity does not have authorized trusted partners, control passes down to block 142 where processor 25 accesses the patient chart data that is maintained by the requesting entity without seeking additional data from other EMR systems.

Referring still to FIG. 8, at block 126, where the requesting entity has authorized trusted partners, control passes to block 128 where processor 25 next determines whether or not a patient visited entities list exists for the requesting entity. Here, where only the requesting entity is included in column 70 for a patient, the single entry is not considered a “list.” Where the PVE column 70 includes additional entities (i.e., more then the requesting entity is included in column 70 for a patient), control passes to block 142 where, again, processor 25 accesses only the patient chart at the requesting entity and does not seek additional information from the other entities for the patient. In this example, as described above, it is assumed that if a PVE list includes additional entities, those additional entities are already automatically synchronizing the decision support data and/or scheduling data with other entities on the PVE list for the particular patient and therefore there is no need to access that data again from the additional entities.

The initial time through the process shown in FIG. 8 for any one of the entities in a trusted partner subset for a specific patient, there will be no additional entities in the patient visited entities list and control passes to block 130. At block 130, the requesting entity transmits the patient data request to each of the trusted partner entities in subset 60. At block 132, the requesting entity monitors the network 40 for any return data from trusted partner entities. In at least some embodiments it is contemplated that when a trusted partner entity receives a request for patient data, if the EMR system associated with the trusted partner entity does not maintain data for the patient indicated in the request, the trusted partner entity will transmit a signal back to the requesting entity indicating that no data exists. In other cases, the processor monitoring for return data will include a timer to timeout a threshold period after which it is assumed that trusted partner entities that do not return data have none for a particular patient.

At block 134, where no return data is received from trusted partner entities, control passes to block 142 where processor 25 accesses patient chart data at the requesting entity. In the event data is returned at block 134 from one or more of the trusted subset entities, control passes to block 136 where the return data is stored in the patient chart for the specific patient that is maintained by the requesting entity. Next, at block 138, the requesting entity stores a list of the trusted partner entities that returned data for the patient thereby increasing the length of the PVE list at the requesting entity for the specific patient. After block 138 control passes to block 142 where the processor 25 accesses the patient chart data stored by the requesting entity including the data newly added from the trusted partners at block 136. Control passes to block 140 where the requesting entity processor presents the patient chart via the terminal 50 used to issue the request. After block 140, control passes back up to block 122 where processor 25 again monitors for a patient chart request.

It has been recognized that in a system where entities are capable of automatically accessing or obtaining data maintained by multiple EMR systems and updating patient charts and schedules, physicians may come to assume that automatic synchronization occurs and that a data set that reflects all trusted subset entity EMR data is always presented. Here, where a patient opts out of automatic data sharing among trusted subset entities, physicians may therefore be operating under a false assumption. To avoid this scenario, in at least some embodiment it is contemplated that when a patient does not authorize data sharing among all trusted subset entities, when a patient chart data view or scheduling view is provided to a physician, a notice may also be provided that indicates that the view does not include any data from specific ones of the trusted subset entities. In some cases the notice may even generically indicate data that is known to exist in other trusted subset entity EMR systems that is missing from a chart or scheduling view. For instance, where the fifth subset entity 20 has not been authorized to share data with subset 60 but entity 20 includes an allergy not included in the allergy lists maintained by entities 12 through 18, when a physician accesses a patient chart at entity 12, the chart may include a highlighted or otherwise visually distinguished indication proximate an allergies list indicating that entity 20 includes an additional unshared allergy. This notice may prompt the physician to seek patient authorization anew to share data with entity 20 so that a complete data set can be viewed.

It has also been recognized that, in at least some embodiments, it would be advantageous if system processes would indicate when data elements have been synchronized among trusted partners. Here, the processes may generally indicate synchronization by indicating something like “Data presented in this claim chart has been synchronized with trusted partners.” In other cases the indication may specifically indicate all entities for which synchronization has occurred, may indicate which data in a chart has been synchronized, may indicate which entity is responsible for initially generating which data, etc. In some cases data synchronized or subject to synchronization may be indicated by providing a special “trusted partners” or “synchronized” icon or the like to distinguish that data from other chart data.

In still other embodiments, it may be that data automatically updated among trusted partners only amounts to a small percentage (e.g.,. 1%) of the total data maintained by the partners and that patient charts in this case would simply visually distinguish other chart data known to have updates in other trusted partner EMRs. For instance, other chart data known to have updates in other EMRs may be highlighted or may be tagged with specific on-screen icons. Here, in at least some cases, the highlighted data or icon may be selectable (e.g., via a mouse controlled cursor or the like) to trigger an update between trusted partners of the associated data.

Referring now to for FIG. 9, a process 150 that is performed by a trusted partner entity receiving a patient chart request is illustrated. Referring also to FIG. 1, process 150 will be described in the context of an exemplary chart request from first entity 12 which is received by second entity 14. In FIG. 9, at block 152, a second entity processor 35 (see again FIG. 1) monitors network 40 for any type of transmission to the second entity. At block 154, where no transmission is received, control passes back up to block 152 where the monitoring process continues. Once a transmission is received at block 154, control passes to block 156 where the second entity processor 35 determines whether or not the received transmission is from a trusted partner entity. When the transmission is not from a trusted partner entity, control passes to block 170 where the received transmission is processed in some other fashion. At block 156, where the transmission is from a trusted partner entity, control passes to block 158 where the second entity processor determines whether or not the transmission is a data request. Where the transmission is not a data request, control passes to block 212 in FIG. 11 which is described below.

Where the transmission includes a data request at block 158, control passes to block 160 where second entity processor 35 determines whether or not the receiving trusted partner (in this case the second entity 14) maintains a chart for the patient indicated in the data request. Where the receiving trusted partner entity does not maintain a chart for the patient, control passes to block 172 where the receiving entity transmits an indication back to the requesting entity that the receiving entity does not maintain a chart for the patient.

At block 160, where the receiving entity does maintain a chart for the patient, control passes to block 162. At block 162, the requesting entity is added to the patient visited entities list at the receiving entity. At block 164, the second entity processor 35 (i.e., the processor associated with the receiving entity) accesses the patient chart data maintained by that entity's EMR system for the patient indicated in the request and at block 166 the processor gleans data from that patient chart data including, for instance, decision support data. The gleaned patient data is transmitted at block 168 back to the requesting entity after which control passes back up to block 152 where the second entity processor continues to monitor for transmissions from other entities linked to the network 40.

Referring now to FIG. 10, a process 190 by which each of the entities in the trusted partner subset 60 monitors for modifications to the first data subset and then pushes the modified first data subset to other trusted subset entities is illustrated. At block 192, an entity processor monitors for modifications to the first data subset associated with a specific patient made via a terminal associated with the entity. At block 194, where the first data subset is not modified for a specific patient, control passes back up to block 192 where monitoring continues. Once the first data subset has been modified at an entity for a specific patient, control passes to block 196 where an entity processor stores the modified first data subset via the EMR system associated with the entity used to modify the first data subset. For instance, where the first data subset was modified via entity 12 in FIG. 1, the modified first data subset for the patient would be stored via the first EMR system 26.

After block 196, at block 198, the entity processor accesses the patient authorization database associated with the entity (see again FIG. 4) and determines whether or not a PVE list exists for the specific patient. For instance, referring again to FIG. 4, where first data subset has been modified for patient P2 via the first entity 12, as shown in column 70, a PVE list exists which includes entities in addition to the first entity used to modify the first data subset. In this case, control passed from block 198 down to block 200 where the modified first data subset is transmitted by the entity processor to each entity on the patient visited entities list. In the example shown in FIG. 4, the only entity in addition to the first entity on the list corresponding to patient P2 is the fifth entity and therefore the modified first data subset is transmitted to the fifth entity at block 200 in the present example. After block 200 control passes back up to block 192 where monitoring for modifications to the first data subset continues. Referring again to block 198, where no PVE list exists for a patient (i.e., the patient has only visited one of the trusted partner entities in a subset), control passes from block 198 back up to block 192 where monitoring for modifications to the first data subset data continues.

Referring now to FIG. 12, an exemplary sub-process 210 that is performed by each of the trusted partner entities in subset 60 (see again FIG. 1) for accepting modified shared data from other trusted partner entities and storing that data for subsequent use in generating patient charts is illustrated. Referring also and again to FIG. 9, at block 158, where a received transmission is not a data request, control passes from block 158 to block 212 in FIG. 12. Here, referring still to FIG. 9, it should be appreciated that the sequence of steps prior to block 158 require that a transmission be received at an entity and that the transmitting entity is a trusted partner (see blocks 154 and 156). Thus, at block 212, a transmission has been received from a trusted partner where the transmission is not a data request. At block 212, the receiving entity processor determines whether or not the received transmission includes first subset data where the first subset data includes data to be synchronized among trusted subset entities (e.g., decision support data, scheduling data, etc.). Where the received transmission does not include first subset data, control passes back up to block 152 in FIG. 9 where transmission monitoring continues. At block 212, where a first subset data transmission is received, control passes to block 214 where the receiving entity stores the modified first subset data for the patient after which control passes back up to block 152 in FIG. 9 where monitoring continues.

In at least some embodiments it is contemplated that when first subset data is modified by one of the trusted partner entities, the shared data may be posted for access by other trusted partner entities allowing the trusted partner subset 60 entities to access the hosted data at a later time. For example, in at least some embodiments, trusted partner subset entities may be programmed to access posted first subset data modifications at preset times (e.g., every hour) in order to reduce overhead required to facilitate data sharing among the entities. To this end, FIG. 11 shows a process 190a similar to the process 190 in FIG. 10, albeit where step 202 may be performed instead of step 200 when a PVE list exists. In step 202, first subset data is posted for access by entities on the PVE list as opposed to being pushed to these entities. In FIG. 12, steps similar to steps in process 190 shown in FIG. 10 are labeled with the same numbers followed by an “a”. Thus, the only distinction between processes 190 and 190a is that push block 200 has been replaced by post block 202.

Referring once again to FIG. 12, decision step 212 may be replaced by steps 216, 218 and 220 as shown in FIG. 13 wherein, at block 216, an entity processor periodically access the patient authorization database (see again FIG. 3) maintained by the entity and identifies, for each patient in column 66, PVE in column 70. At block 218, the entity processor communicates with each PVE to identify if first subset data modifications have been posted. Where modifications have not been posted, control passes back up to block 216 where the entity processor continues to step through steps 216 and 218. Once first subset data modifications have been posted at block 218, control passes to block 220 where the entity processor obtains the modified first subset data from the patient visited entities after which control passes back down to block 214. The other step 214a in process 210a is similar to step 214 in process 210 in FIG. 12.

While the system described above synchronizes only a portion of patient data among different EMR systems, in at least some embodiments it is contemplated that all EMR system data for patients may be shared among different EMR systems and stored in each system.

In addition, while the system above facilitates patient data synchronization among entities visited by a patient, in other embodiments data may be synchronized among all authorized trusted subset entities irrespective of whether or not a patient has visited each subset entity. In effect, all trusted subset entities would maintain a patient chart for each patient that visits any of the subset entities.

In some embodiments, where a physician at a first entity schedules an appointment for a patient with another physician at a second trusted subset entity that does not have a chart for the patient when the appointment is scheduled, the patient chart data may be automatically provided to the second entity so that a patient chart can be generated in the second entity's EMR system for the patient prior to the patient's arrival. Here, upon arrival at the second entity, registration can be expedited as much of the patient's chart data already exists in the second entity's EMR system. Thus, patient data may be pushed automatically to authorized trusted subset entities with which a patient has an appointment prior to an initial visit from the patient to the entities.

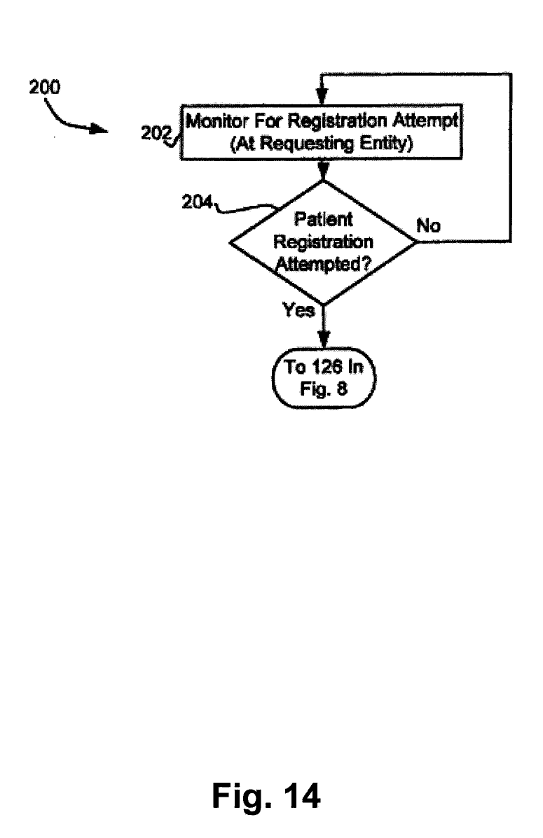

In addition, even if patient data is not pushed to a second trusted subset entity when an initial appointment at the entity is scheduled via a trusted partner entity, upon registration at the second entity and prior to an appointment for the patient, the second entity may automatically seek patient data from the other trusted partner entities, store returned data in the second entity's EMR system that will subsequently be useful to generate a patient chart view and/or a scheduling view for the patient, and may automatically fill in registration fields in an electronic registration form required at the second entity prior to the appointment. Thus, access to other EMR system data may be initiated either upon registration or a request for a specific patient view. To this end, blocks 122 and 124 in FIG. 8 may be replaced by the subprocess 200 shown in FIG. 14. At block 202, a processor monitors a registration terminal (see 50 in FIG. 1) for an attempt to register a patient for an appointment at the entity. At block 204, where registration is not attempted, control passes back up to block 202 where monitoring continues. Where registration commences at block 204, control passes to block 126 in FIG. 8 where the entity at which the patient is registering is a requesting entity. The process shown in FIG. 8 is then performed to obtain patient data from other trusted subset entities that is then stored in the EMR system associated with the entity at which the patient is registering. At block 140, instead of generating a patent chart, the registering entity generates an electronic registration form that includes at least some fields automatically filled in with data from the registering entities EMR system. Here, data retrieved from the other trusted subset entities may include more than the first data subset so that even patient data that falls in the less important category (i.e., non-decision support data) is obtained and used to fill in the registration form as well as the patient data in the registering entities EMR system.

In some embodiments it is contemplated that while a physician is viewing a patient schedule view, the view will present schedules for resources affiliated with each or a subset of the trusted subset entities. Here, the physician may be able to schedule patient appointments at multiple trusted subset entities from any one of the trusted subset entities. For instance, where a PCP at a first entity wants to schedule labs at a second entity, imaging at a third entity and a follow-up visit at the first entity, a single unified scheduling view for all three entities may be provided so that the PCP can coordinate scheduling of all three patient activities. Once activity times are selected, the selections are treated as first data subset modifications and are automatically provided to each of the authorized trusted subset entities which in turn update their patient data for the patient and resource schedules accordingly.

In some embodiments it is contemplated that trusted subset entities will be able to agree upon and adopt rules governing which employees at trusted subset entities will be able to access data shared among the entities. For instance, in some cases only physicians may be able to view decision supporting data while administrators are barred. In other cases, only certain types of specialists or even specific physicians may be able to view certain test results, prescriptions, etc., while others are barred.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

To apprise the public of the scope of this invention, the following claims are made:

What is claimed is:

1. A method for sharing patient medical records among a plurality of separate entities wherein each of the entities maintains a separate electronic medical records (EMR) system that stores patient data usable to generate patient data views, the method comprising the steps of:
receiving a first data request associated with a first patient via a first entity where the first entity is a requesting entity;
in response to the first data request:
automatically identifying a trusted subset of entities from the plurality of entities;
automatically identifying the EMR systems associated with the identified trusted subset of entities that maintain at least a subset of data associated with the first patient;
using the subsets of data from the EMR systems associated with the identified subset entities to update patient data maintained by the requesting entity wherein the patient data includes patient medical chart data usable to generate a patient medical chart; and
using the updated patient data maintained by the requesting entity to generate and present a patient medical chart via a display.

2. The method of claim 1 wherein the step of automatically identifying the EMR systems includes automatically transmitting a data request to each of the trusted subset entities requesting data for the first patient and receiving data associated with the first patient back from at least a subset of the trusted subset of entities.

3. The method of claim 1 further including the step of establishing a trusted subset of entities including the requesting entity.

4. The method of claim 3 wherein the step of establishing a trusted subset of entities includes storing a trusted subset list identifying each trusted subset entity at each of the trusted subset entities.

5. The method of claim 1 wherein the plurality of entities include non-trusted entities in addition to the trusted subset entities and wherein the method further includes the steps of, when data maintained by an EMR system associated with at least one of the non-trusted entities is to be accessed, using the requesting entity to manually identify at least one of the non-trusted entities from which to obtain patient data and transmitting a query to the at least one non-trusted entity.

6. The method of claim 1 further including the steps of, subsequent to presenting the patient view, synchronizing the data used to generate the patient data view among the EMR systems associated with the trusted subset entities each time the data used to generate the patient data view is updated.

7. The method of claim 6 wherein the patient data maintained by the trusted subset entities includes first and second subsets and wherein only the first subset of patient data is used to generate the patient data view.

8. The method of claim 7 wherein the first subset includes at least one of decision support patient chart data and patient scheduling data.

9. The method of claim 8 wherein the first subset includes both decision support patient chart data and patient scheduling data.

10. The method of claim 8 wherein the first subset of data includes at least one of a list of patient problems, a list of allergies, a list of medications, a list of immunizations and a list of lab results.

11. The method of claim 1 wherein at least a subset of the data associated with a first patient is automatically synchronized data, each of the trusted subset entities from which patient data is obtained in response to the data request stores patient data for the first patient, the method further including the steps of storing a patient visited entities (PVE) list at the requesting entity wherein the PVE list identifies the trusted subset entities from which data is obtained in response to the data request and, when automatically synchronized data is modified at the requesting entity, the method including transmitting the modified automatically synchronized data to each of the entities on the PVE list and each of the entities on the PVE list using the modified automatically synchronized data to automatically update the patient data maintained by the entity.

12. The method of claim 11 wherein each of the entities on the PVE list also maintains a PVE list, the method further including the steps of, when automatically synchronized data is modified at any of the entities on the PVE list, the entity transmitting the modified automatically synchronized data to each of the entities on the PVE list and the entities receiving the modified automatically synchronized data using the modified data to update the patient data maintained by the entity.

13. The method of claim 12 further including the step of, receiving subsequent data requests associated with a first patient via the requesting entity that are subsequent to the first data request, in response to each of the subsequent data requests, accessing only chart data maintained by the EMR system associated with the requesting entity and using the accessed chart data to generate and present a patient chart for the first patient via a display associated with the first entity.

14. A method for sharing patient medical chart data among a plurality of separate entities, the method comprising the steps of:
associating separate electronic medical records systems with each of the plurality of entities wherein each medical records system stores data for generating patient data views;
establishing a trusted relationship between a subset of the plurality of entities where entities having the trusted relationship form a trusted subset, the plurality of entities including non-trusted entities in addition to the trusted subset entities, trusted subset entities that have generated a patient view for a first patient comprising a first patient visited entities (PVE) subset; and
the first PVE subset entities automatically synchronizing at least patient data subsets among the separate electronic medical records systems associated with the first PVE subset entities so that all of the PVE subset entities include current automatically synchronized data subsets.

15. The method of claim 7 wherein the automatically synchronized data subsets include data that is routinely used to facilitate medical decisions.

16. The method of claim 8 wherein the patient data includes patient medical chart data and the patient data views are patient charts.

17. The method of claim 8 wherein the patient data is scheduling data and the patient data views are patient scheduling views.

18. A method for sharing patient medical records among a plurality of separate and unaffiliated entities, the method comprising the steps of:
associating separate electronic medical records (EMR) systems with each of the plurality of entities wherein each EMR system stores data usable to generate patient data views;
establishing a trusted relationship between a subset of the plurality of entities where entities having the trusted relationship form a trusted subset;
automatically sharing patient data among at least a subset of the trusted subset entities; and
when data is received from one of the trusted subset entities, the EMR system associated with the receiving entity using the received data to update the patient data stored by the receiving entity.

19. The method of claim 18 wherein patient data includes first and second data subsets and wherein the step of automatically sharing includes automatically sharing only the first data subset.

20. The method of claim 19 wherein the first data subset includes at least one of decision support patient data and scheduling data.

21. The method of claim 18 wherein the step of automatically sharing includes sharing as patient data is generated at any one of the trusted subset entities.

22. The method of claim 18 wherein the step of automatically sharing includes, when one of the trusted subset entities is initially visited, automatically requesting the patient data maintained by at least one of the other trusted subset entities during a registration process and automatically storing patient data in the EMR system associated with the receiving entity.

23. The method of claim 18 wherein the step of automatically sharing includes, when a patient is referred to one of the trusted subset entities an initial time, after the referral is issued, automatically providing the patient data to the one of the trusted subset entities and automatically storing the patient data in the EMR system associated with the receiving entity.

24. A system for sharing patient medical records among a plurality of separate entities wherein each of the entities maintains a separate electronic medical records (EMR) system that stores patient data usable to generate patient data views, the system comprising:
a processor programmed to perform the steps of:
receiving a first data request associated with a first patient via a first entity where the first entity is a requesting entity;
in response to the first data request:
automatically identifying a trusted subset of entities from the plurality of entities;
automatically identifying the EMR systems associated with the identified trusted subset of entities that maintain at least a subset of data associated with the first patient;
using the subsets of data from the EMR systems associated with the identified subset entities to update patient data maintained by the requesting entity wherein the patient data includes patient medical chart data usable to generate a patient medical chart; and
using the updated patient data maintained by the requesting entity to generate and present a patient medical chart via a display.

25. A system for sharing patient medical chart data among a plurality of separate entities, the system comprising:
at least one processor programmed to perform the steps of:
associating separate electronic medical records systems with each of the plurality of entities wherein each medical records system stores data for generating patient data views;
establishing a trusted relationship between a subset of the plurality of entities where entities having the trusted relationship form a trusted subset, the plurality of entities including non-trusted entities in addition to the trusted subset entities, trusted subset entities that have generated a patient view for a first patient comprising a first patient visited entities (PVE) subset; and
automatically synchronizing at least patient data subsets among the separate electronic medical records systems associated with the first PVE subset entities so that all of the PVE subset entities include current automatically synchronized data subsets.

26. A system for sharing patient medical records among a plurality of separate and unaffiliated entities, the system comprising:
at least one processor programmed to perform the steps of:
associating separate electronic medical records (EMR) systems with each of the plurality of entities wherein each EMR system stores data usable to generate patient data views;
establishing a trusted relationship between a subset of the plurality of entities where entities having the trusted relationship form a trusted subset;
automatically sharing patient data among at least a subset of the trusted subset entities; and
when data is received from one of the trusted subset entities, using the received data to update the patient data stored by the receiving entity.
